(19) United States
(12) Patent Application Publication
(10) Pub. No.: US 2015/0303734 A1
(43) Pub. Date: Oct. 22, 2015

(54) Induction Charger

(71) Applicant: KNIGHTSBRIDGE PORTABLE COMMUNICATIONS SP, Grand Cayman (KY)

(72) Inventor: Lewis Daniels, Allier (FR)

(73) Assignee: Knightsbridge Portable Communications SP, George Town, Grand Cayman (KY)

(21) Appl. No.: 14/646,070

(22) PCT Filed: Nov. 20, 2013
(86) PCT No.: PCT/GB2013/053063

§ 371 Date: May 20, 2015

(30) Foreign Application Priority Data
Nov. 21, 2012 (GB) 1220930.0

(51) Int. Cl. H02J 7/02; H02J 7/00

(52) U.S. Cl. CPC H02J 7/025; H02J 7/0044

(57) ABSTRACT

The invention relates to an induction charging apparatus (2) for use in charging portable computing devices (8) such as laptops, tablet computers, mobile (cellular) telephones which require a high degree of security due to the nature of the data which is stored on the device e.g. military, financial, personal data etc. The invention provides a system comprising an induction charging device (2) and a computing device (8) to be charged by the charging device. Charging is enabled by successfully pairing two paired devices. The computing device can be configured such that it can only be charged by said induction charging device.

### CROSS-REFERENCE TO RELATED APPLICATIONS

This application is the national stage of International Patent Application No. PCT/GB2013/053063 filed on Nov. 20, 2013, and which claims priority to British Patent Application No. GB 1220930.0 filed on Nov. 21, 2012, both of which are hereby incorporated by reference in their entireties as if fully set forth herein.

### BACKGROUND

1. Field

The present invention relates to an induction charging apparatus.

2. Related Art

It is particularly suited for use in charging computing devices, especially portable computing devices such as laptops, tablet computers, mobile (cellular) telephones and so on. It is also particularly suited for use with computing devices which require a high degree of security due to the nature of the data which is stored on the device e.g. military, financial, personal data etc.

Inductive coupling is utilised in many devices such as electric toothbrushes or through the provision of a charging mat can recharge multiple devices simultaneously. Inductive coupling utilises magnetic fields that are a natural part of a current's movement through a wire. As electrical current moves through the wire it creates a circular magnetic field around the wire providing a magnetic field. Providing a coil in the wire amplifies the magnetic field and thus a magnetic field can be increased by utilising more loops of coil.

A second coil of wire is placed into the magnetic field and a current is induced in this second wire. This connects to the battery in the device to be charged and thus recharges the battery.

Utilising inductive coupling in this manner to recharge electronic devices is extremely beneficial as a physical connection is not required. However, in some instances it is undesirable for an electronic device to be charged without sufficient security. For example, in the event of sensitive information being provided on the electronic device which may, for example, be a mobile telephone, a third party can easily charge the device thus providing significant time for access to the device without having to rely on the device's battery power. Experts in obtaining data from the device could then be employed to remove the data.

### SUMMARY

The present invention therefore provides an improved arrangement which overcomes security based deficiencies associated with induction charging of devices not previously considered. The invention provides an induction charging system and method as defined in the appended claims.

Thus, there is provided a system comprising:
an induction charging device; and
a computing device configured for charging by the induction charging device;
   wherein charging of the computing device by the induction charger is enabled by successfully pairing two paired devices.

Thus, the system may be configured such that two or more predetermined devices must be paired in order for the charging to begin and/or be maintained. The paired devices may be paired via software or hardware means. This pairing requires that each of the paired devices is known to the other. The pairing may be achieved via a communications protocol. The pairing process may be used to link the individual devices such that they can communicate. The pairing process logically connects the two devices so that they are known to each other. The pairing process may require that the paired devices perform a handshake operation. The pairing process may establish a wireless communication link between the paired devices. The pairing may be performed via Bluetooth™. Pairing of the paired devices involves a process which goes beyond authentication or identifier matching.

The system may be configured for inductively charging a power supply of a computing device. The computing device may be a portable device. It may be a mobile computing device. It may comprise processing capabilities, such as a smart phone, a tablet computer, a laptop computer, or a PDA. It may comprise a microprocessor. The activities of the computing device may be coordinated by an operating system.

The computing device (which may simply referred to hereinafter as ‘the device’ or ‘the device to be charged’) may be configured such that it can only be charged by said induction charging device. Thus, in order to charge the computing device the user must be in possession of (or at least have access to) the specific induction charging device. This provides enhanced security because if an unauthorised party gains access to the computing device e.g. by stealing it, he will be unable to charge the computing device without the specified charging device.

Charging of the computing device by the induction charger may only enabled by successfully pairing two paired devices. This provides the benefit that in order to charge the computing device the user must be in possession of (or at least have access to) the paired devices. This provides enhanced security because if an unauthorised party gains access to the computing device e.g. by stealing it, he will be unable to charge the computing device without the ability to pair the paired devices.

One of the paired devices may be the computing device.

Additionally or alternatively, one of the paired devices may be the induction charging device.

Additionally or alternatively, one of the paired devices may be an intermediary device. The intermediary device may be referred to hereinafter as a ‘key element’. The intermediary device may be arranged for wireless communication with the computing device and/or the induction charging device. The intermediary device may be physically separate from the computing device and/or the induction charging device.

The induction charging device may be enabled to charge the computing device. Additionally or alternatively, the computing device may be enabled to be charged by the induction charging device in the event of a positive identification signal transferred therebetween.

Thus, the system may be arranged such that charging of the computing device is enabled when pairing of the devices has been accomplished, and disabled when pairing has failed. The system may switch between the enabled and disabled states. Charging of the computing device may be dependent upon continued pairing of the devices, such that upon loss of paired connectivity between the two specified devices charging ceases.

The system may comprise an arrangement for sending or receiving an identification signal such that a positive identification signal transmitted between the induction charging device and the computing device enables the induction charging device to charge the computing device and/or enables the computing device to be charged by the induction charging device.

Preferably, pairing of the paired devices is only possible when the devices are within a predetermined range. Pairing may only be possible when the paired devices are within proximity to each other. This provides the benefit that the user must be in possession of (or at least have access to) both the paired devices in order for charging to be performed.

The computing device, the induction charging device and/or the intermediary device may comprise a secure processor. This provides added security.

Also in accordance with the invention, there is provided a computing device configured for use with (i.e. being charged by) a system as described above. The computing device may be configured such that it can only be charged by a specified induction charging device.

Also in accordance with the invention, there is provided an induction charging device configured for use with a charging system as described above. The induction charging device may be configured such that it may charge only a specified computing device.

Also in accordance with the invention there is provided a method of charging a computing device, the method comprising the step:
enabling the computing device to be charged by an induction charging device upon successful pairing of two paired devices.

According to an alternative wording, the present invention provides an induction charging system comprising an induction charging station comprising means for establishing congruity between the charging station and a device to enable the charging station to charge the device and/or enable the device to be charged by the charging station. Congruity is established when, for example, at least two devices are paired via hardware and/or software means.

Prior art systems will charge any device brought suitably close to the induction charging station however the presently claimed invention means that congruity must be established between at least two of: the charging station, the device to be charged, and an intermediary (key) device.

This congruity may take a variety of forms. Congruity in this context refers to a pairing or matching that goes beyond mere ability to establish any kind of transfer for communication. Instead it could, for example, refer to the agreement of identification information available to each of the congruent (paired) entities. Hence congruity could for example be established by successful comparison of identification information. It is beneficial that congruity is achieved when there is a predetermined acceptance level between the charging station and the device. Congruity is preferably achieved providing the acceptance level is reached. This means that a device cannot be charged without overcoming a security barrier(s), and then if the congruity (pairing) is not established thereby not reaching security requirements the use of the device would only be limited to the life of the battery having the present amount of charge. Assuming that congruity is established between the charging station and a device, in one embodiment the charging station is enabled to charge the device. Alternatively or in addition, the computing device can be enabled to effectively allow the computing device to be charged by the charging station.

Preferably, the intermediary key element has no external ports.

Preferably in combination with an electronic device that has no external data ports this provides a system of high security as the data on the device can be configured to be inaccessible after the battery life has expired.

The induction charging system comprising an induction charging station is preferably enabled to charge the device in the event of a positive identification signal transferred therebetween. The induction charging system comprising an induction charging station preferably comprises an arrangement for sending or receiving an identification signal such that a positive identification signal transmitted between the charging station and the device enables the station to charge the device. The arrangement for sending or receiving an identification signal is preferably arranged to send and/or receive a wireless signal.

It will be appreciated that a variety of means may be provided for providing an identification signal. In one embodiment, near field communication (NFC) may be utilised which requires radio communication between the induction charging station and the device. Accordingly, the induction charging station may include a device to transmit an identification signal to an arrangement for receiving a signal provided in the device to be charged and in the event of a positive identification then charging is enabled. It will be appreciated that in the alternative, the device to be charged may transmit a signal to the induction charging station which includes a device to receive a signal and if the signal is a positive identification signal or is a correct signal then charging is enabled. It will further be appreciated that any signal that is transmitted may be encrypted and may be decrypted by the receiving device. It will be appreciated also that both the induction charging station and the device to be charged may incorporate a near field communication device or one of the induction charging station and the device to be charged may include a near field charging device whereas the other device may include an unpowered near field communication chip, called a ‘tag’.

Although the description has been made with reference to near field communication, other communication fields may be utilised such as, for example, Bluetooth®.

The induction charging system preferably further comprises an intermediary key element configured to allow switching of the means for establishing congruity between the charging system and the device from a disabled to an enabled configuration. The key element beneficially enables or activates or allows the means for establishing congruity to be activated.

The key element is preferably physically separate from the charging station and a device to be charged.

A wireless identification signal is preferably transmitted to and/from the key element to the charging station or a device to enable the charging station to charge the device.

The key element provides significant advantages. The key element effectively authenticates the means for establishing congruity between the charging station and a device to enable a station to charge the device. With the provision of the key charging therefore cannot occur unless specific circumstances are apparent. Preferably the key works as a proximity device. This means that once the key is within a certain distance from the device to be charged and/or the induction charging station, then charging is enabled. The wireless identification signal may originate from the device to be charged or the induction charging station or the key. However, charging will not be enabled unless a positive identification between in one embodiment the key and the induction charging station is achieved, alternatively wherein a positive identification is achieved between the key and the device to be charged. It will be appreciated that in an alternative or addition, identification is required between the key and both the induction charging station and the device to be charged. The identification signal may be transferred over a communication network such as, for example, Bluetooth® or Wi-Fi. Bluetooth is beneficial due to the separation distances between the key and the induction charging station or the device to be charged meaning that the key must be close to the induction charging station and the device to be charged.

The key is beneficially matched (i.e. paired) to a device to be charged and/or to the charging station in order to form a connection network therebetween. As described above, there are various forms of connection network that may be utilised that are well known in the art.

Once a connection is established between the key element and the charging station and/or a device to be charged, the means to establish congruity between the charging station and a device to be charged is enabled.

A communication element is beneficially provided for incorporation into a device to be charged arranged to communicate with the charging station. The communication element is beneficially further configured to communicate with key element. The communication element is preferably configured to communicate over a wireless network.

The present invention also provides a charging system comprising an induction charging station for charging a device and a key element, the system arranged such that when communication between the key element and the device or the charging station is established, charging of the device is enabled.

In this embodiment it will be appreciated that no congruity is essential (although is preferable) between the charging station and the device, there is a requirement for communication between the key element and the device or charging station to be established before charging of the device is enabled.

Although such an embodiment does not provide the security of the additional requirement for congruity between the charging station and the device, the security element is provided as it is necessary for the key element if charging is to be achieved.

Communication between the key element and the device or charging station is beneficially by wireless communication. In the event that communication between the key element and the device or the charging system is not established, then charging of the device is non-enabled.

It will be appreciated that it is further beneficial for congruity to be established between the charging system and the device to be charged to enable the charging station to charge the device. The preferred features of such an arrangement are common to both the first and second aspects of the present invention and accordingly, have not been repeated here.

Preferred features described in relation to the first aspect or embodiment may also be preferred in relation to the second or subsequent aspects or embodiments of the invention.

Reference is now made to the drawings wherein the exemplary embodiments of the present invention are shown.

### BRIEF DESCRIPTION OF THE DRAWINGS

FIG. 1 is a schematic diagram of an exemplary embodiment of the present invention according to a first aspect.

FIG. 2 is a schematic diagram of an exemplary embodiment of the present invention according to a first aspect.

FIG. 3 is a schematic diagram of an exemplary embodiment of the present invention according to a first aspect.

FIG. 4 is a schematic diagram of an exemplary embodiment of the present invention according to a second aspect.

FIG. 5 is a schematic diagram of an exemplary embodiment of the present invention according to a second aspect.

### DETAILED DESCRIPTION

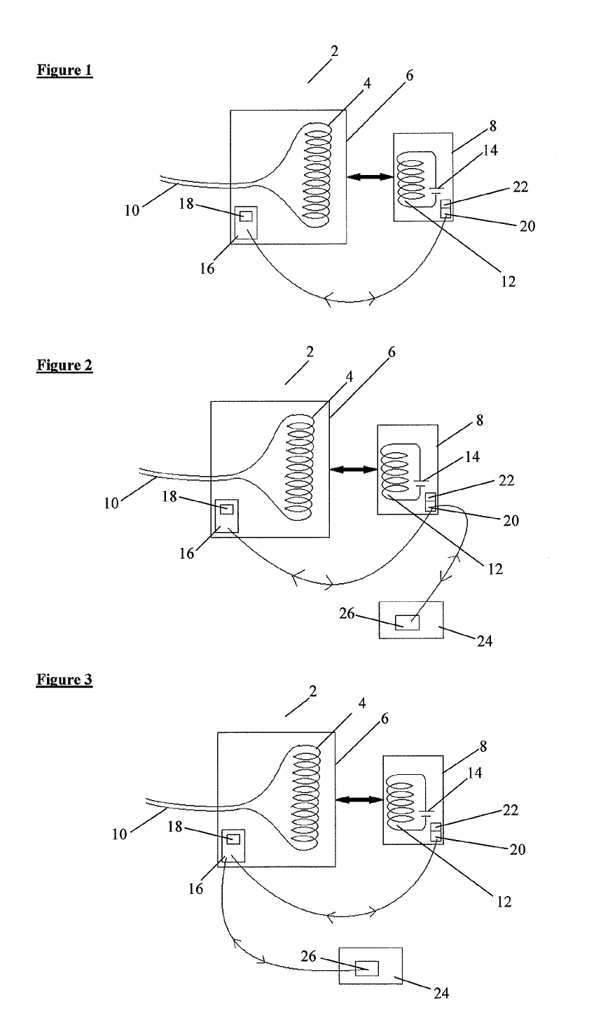

Referring to FIG. 1 there is an induction charging device (station) 2 which includes a coil 4 and beneficially comprises a portion 6 adjacent which or onto which a device 8 to be charged may be seated or positioned. The charging station 2 is connected to a mains input via cable 10. The device to be charged includes a corresponding coil 12 and a battery 14.

In one embodiment the charging station 2 comprises a transmitter 16 for transmitting a signal. The transmitter may include an encryption processor 18 configured to encrypt the signal. The device 8 beneficially includes a receiver 20 which is arranged to receive a signal from the transmitter 16 assuming that, for example, the signal is of the correct frequency or within the correct frequency range. The signal may be arranged to be decrypted by a decryption processor 22 provided in the device 8. Near field communication (NFC) is a beneficial standard for establishing radio communication between the charging station 2 and the device 8 as it requires close proximity of usually no more than a few centimetres.

Different communication modes are possible such as the transmitter 16 provides a carrier field and the receiver 20 answers by modulating the existing field. Accordingly, the receiver 20 may draw its operating power from the transmitter 16 generated electromagnetic field, thus effectively making the receiver 20 a transponder. Alternatively, both the transmitter 16 and the receiver 20 communicate by alternately generating their own field. Either device is arranged to deactivate its radio frequency field while it is waiting for data. In this type of mode both the charging station and the device utilise their own power supply. It will be appreciated that in an alternative embodiment the device 8 may comprise a transmitter 20 and the charging station 2 may comprise a receiver 16. It will also be appreciated that devices 16 and 20 may be transceivers.

In use, therefore, the device to be charged 8 is brought into proximity to the charging station 2. Congruity (pairing) is achieved between the devices 16 and 20 which enables charging to occur. A switch (not shown) may therefore be switched once congruity (pairing) between the devices 16 and 20 is achieved which may enable one or both of the charging station 2 or device to be charged 8 to become active and enable charging to be completed.

Referring to FIG. 2, a second embodiment of the present invention is shown and like features with respect to the first embodiment have the same reference numerals. In this embodiment which provides increased security for charging of a device 8 there is further provided an intermediary device (key element) 24. The key element 24 is provided to enable charging of the device 8. Without the key element 24, congruity or pairing between the charging station 2 and the device to be charged 8 is not enabled. Without the key element 24 charging of the device 8 is prevented. In one embodiment, prevention may be achieved by the device 20 as shown in FIG. 2 being a transmitter and the transmitter not being activated until an appropriate signal is received wirelessly from the key element 24. Thus communication between the key element 24 and the device 8 must be established before congruity or pairing between the device 8 and the charging station 2 can be achieved. In this embodiment the device 8 must therefore include a receiver for receipt of a signal from the key element 24 and a transmitter for transmitting a signal to the receiver 16.

It is beneficial that an alternative means of transmission be provided between the key element and the receiver 20. A suitable means of communication may be, for example, Bluetooth® as it ensures proximity of the key element 24 to the device 8 and is also a different communication means should the communication means between the device 8 and the charging station 2 be Near Field Communication thereby again providing increased security. In this embodiment the key element 24 is programmed with an address which sends out a radio signal looking for devices having a specific address range via a transmitter 26. If a device has an address in that range then a response via its own transmitter is sent out and thus a network is formed between the device 8 and the key element 24. Once this network is formed a network is effectively provided between the device 8 and the charging station 2.

Referring to FIG. 3, an alternative embodiment of a first aspect of the present application is shown and in this embodiment the key element 24 communicates with a receiver provided in the charging station 2 rather than in the device 8. Functionally, however, the system works in the same manner. It will also be appreciated that in a further embodiment, the key element 24 could be arranged to communicate both with the device 8 and the charging station 2 meaning that the network must be formed between the key element 24 on both of the charging station 2 and the device 8.

A first aspect of the present invention provides significant security for induction charging of a device. Numerous applications are suitable for such an invention providing security between the charging station 2 and the device 8 meaning that congruity between the charging station 2 and device 8 must be established before charging can be completed. Furthermore, an additional layer of security is the requirement for a key element 24 which must further authenticate or enable or allow charging to be carried out. The communication between the key element 24 and the respective receiver in the device 8 or the charging station 2 or both can be further encrypted. An example of the use of such a system could be in an office environment. The device 8 could be a smart phone, tablet computer, PDA, laptop or personal computer that must be charged via the charging station 2. The charging station 2 may be provided in the office and as such, the device 8 cannot be charged away from the office. This means that the device is useless to a third party.

Furthermore an additional layer of security may be the provision of the key element 24 which is provided to the owner of the device 8 meaning that another third party cannot charge the device if they do not have the necessary key element 24. Such technology can be included in a device 8 that has no external charging ports and beneficially may have no external data transfer ports. Such an embodiment may be extremely beneficial when high security is required. For example, in a military environment, the device 8 may be a smart phone type device and may only be charged by the charging station to which it is effectively matched. A key element 24 may also be required to allow charging to be completed. In the event the device 8 was stolen or lost, there are no external charging ports meaning that the charging station 2 is required. A third party trying to access information from the device 8 would therefore only have a limited time until the battery expired during which they could access data on the device. Additionally, in the event that a device 8 has no data ports, then the device could be configured such that in the event of unwanted or unauthorised tampering by attempting to break open the device 8 the data thereon could automatically be deleted.

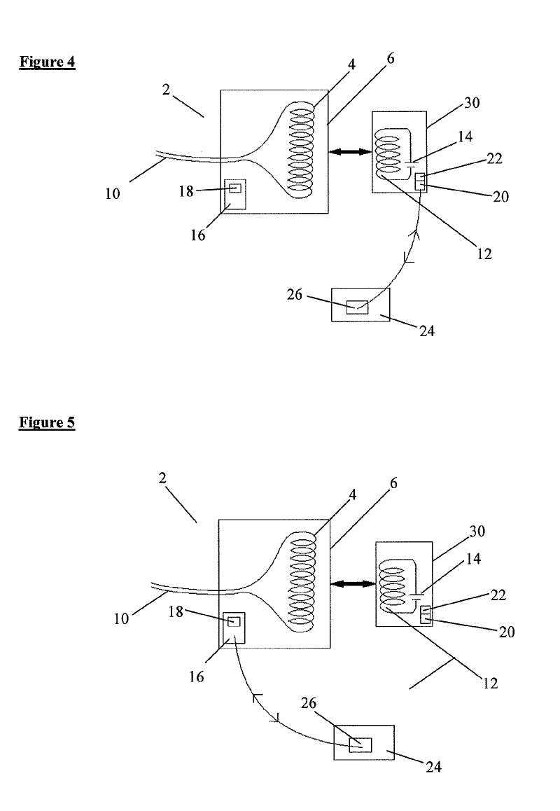

A further embodiment could be the provision of an electrical vehicle that requires induction charging. In such an embodiment congruity is required between the vehicle and the charging station in order that induction charging can be completed. The key element could provide a further layer of security such that it is necessary to enable the charging to be achieved. Accordingly, in the event that the vehicle was stolen, the vehicle could not be charged without a matching induction charging station or alternatively without the provision of the key element. In such an embodiment as briefly described in respect of FIGS. 4 and 5, then the key element is required to enable charging between the vehicle 30 and the charging station 2. In such an embodiment it is not essential that congruity between the charging station 2 and the vehicle 30 is achieved, however, it is essential that a connection between the key element 24 and the vehicle 30 is achieved. An authentication signal is received by the vehicle to allow charging to occur. It will be appreciated that there are other alternative applications for this technology not limited to the embodiments described herein.

FIG. 5 is a schematic system similar to that of FIG. 4, however, in this embodiment connection must be established between the key element 24 and the charging station 2 to enable the charging station to be activated.

The present invention has been described by way of example only it will be appreciated by the skilled addressee that modifications and variations may be made without departing from the scope of protection afforded by the appended claims.

1. An induction charging system, the system comprising:
an induction charging device; and
a computing device configured for charging by the induction charging device,
wherein charging of the computing device by the induction charger is enabled by successfully pairing two paired devices.

2. The system according to claim 1, wherein:
the computing device is configured such that it can only be charged by said induction charging device.

3. The system according to claim 1, wherein:
charging of the computing device by the induction charger is only enabled by successfully pairing two paired devices.

4. The system according to claim 1, wherein:
one of the paired devices is the computing device.

5. The system according to claim 1, wherein:
one of the paired devices is the induction charging device.

6. The system according to claim 1, wherein:
one of the paired devices is an intermediary device arranged for wireless communication with the computing device and/or the induction charging device.

7. The system according to claim 6, wherein:
the intermediary device is physically separate from the computing device and/or the induction charging device.

8. The system according to claim 1, wherein:
the computing device is a portable device comprising processing capabilities.

9. The system according to claim 1, wherein:
the pairing is achieved via a communications protocol.

10. The system according to claim 1, wherein:
the induction charging device is enabled to charge the computing device and/or the computing device is enabled to be charged by the induction charging device in the event of a positive identification signal transferred therebetween.

11. The system according to claim 1, further comprising:
an arrangement for sending or receiving an identification signal such that a positive identification signal transmitted between the induction charging device and the computing device enables the induction charging device to charge the computing device and/or enables the computing device to be charged by the induction charging device.

12. The system according to claim 1, wherein:
pairing of the paired devices only possible when the devices are within a predetermined range.

13. The system according to claim 1 wherein:
the computing device, the induction charging device and/or the intermediary device comprises a secure processor.

14. A computing device configured such that it can only be charged by a specified induction charging device.

15. An induction charging device configured to charge only a specified computing device.

16. A method of charging a computing device, the method comprising:
enabling the computing device to be charged by an induction charging device upon successful pairing of two paired devices.

17. An induction charging system comprising:
an induction charging station comprising means for establishing congruity between the charging station and a device to enable the charging station to charge the device and/or enable the device to be charged by the charging station.

18. The induction charging system according to claim 17, wherein:
the induction charging station is enabled to charge the device and/or the device is enabled to be charged by the charging station in the event of a positive identification signal transferred therebetween.

19. The induction charging system according to claim 17, further comprising:
an arrangement for sending or receiving an identification signal such that a positive identification signal transmitted between the charging station and the device enables the station to charge the device and/or enables the device to be charged by the charging station.

20. The induction charging system according to claim 19, wherein:
the arrangement for sending or receiving an identification signal is arranged to send or receive a wireless signal.

21. The induction charging system according to claim 17, further comprising:
a key element configured to allow switching of the means for establishing congruity between the charging station and the device from a disabled to an enabled configuration.

22. The induction charging system according to claim 21, wherein:
the key element is physically separate from the charging station and a device to be charged.

23. The induction charging system according to claim 21, wherein:
a wireless identification signal is transmitted to and/or from the key element to the charging station or a device to enable the charging station to charge the device and/or enable the device to be charged by the charging station.

24. The induction charging system according to claim 21, wherein:
the key element is matched to a device to be charged and/or to the charging station in order to form a communication network therebetween.

25. The induction charging system according to claim 21, wherein:
once a connection is established between the key element and the charging station and/or a device to be charged, the means to establish congruity between the charging station and the device to be charged is enabled.

26. The induction charging system according to claim 17, further comprising:
a communication element provided for incorporation into a device to be charged arranged to communicate with the charging station.

27. The induction charging system according to claim 21, wherein:
the communication element is further configured to communicate with the key element.

28. The induction charging system according to claim 27, wherein:
the communication element is configured to communicate over a wireless network.

29. A charging system comprising an inductive charging station for charging a device and comprising a key element, the system arranged such that when communication between the key element and the device and/or the charging station is established, charging of the device is enabled.

30. The induction charging system according to claim 29, wherein:
the communication is by wireless communication.

31. The induction charging system according to claim 29, wherein:
in the event that communication between the key element and the device or the charging station is not established, then charging of the device is non-enabled.

32. The induction charging system according to claim 29, wherein:
the induction charging station comprises means for establishing congruity between the charging system and device to enable the charging system to charge the device and/or enable the device to be charged by the charging station.

33. (canceled)

34. A method of charging a device comprising:
providing a charging station and establishing congruity between the device and charging station to enable charging the device.

35. A method of charging a device comprising:
providing an induction charging station and a key element; and
enabling a connection between the key element and the device and/or charging station to enable the device to be charged.
